(19) United States
(12) Patent Application Publication
(10) Pub. No.: US 2025/0258029 A1
(43) Pub. Date: Aug. 14, 2025

(54) FLOW SENSOR, CONTROLLER, AND METHOD WITH CALIBRATION

(71) Applicant: SEMICONDUCTOR COMPONENTS INDUSTRIES, LLC, Scottsdale, AZ (US)

(72) Inventor: Marek HUSTAVA, Bratislava (SK)

(73) Assignee: SEMICONDUCTOR COMPONENTS INDUSTRIES, LLC, Scottsdale, AZ (US)

(21) Appl. No.: 19/070,396

(22) Filed: Mar. 4, 2025

Related U.S. Application Data
(63) Continuation of application No. 19/042,615, filed on Jan. 31, 2025.
(60) Provisional application No. 63/551,338, filed on Feb. 8, 2024.

(51) Int. Cl. G01F 1/667; G01F 1/66; G01M 3/24; G08B 21/18

(52) U.S. Cl. CPC G01F 1/667; G01F 1/662; G01M 3/243; G08B 21/182

(57) ABSTRACT

An illustrative sensor controller includes: a transmitter, a first receiver, a second receiver, a propagation speed circuit, and a level circuit. The transmitter provides a drive signal to an ultrasonic sending transducer to generate an acoustic burst. The first receiver receives a first response signal from a first ultrasonic receiving transducer. The second receiver receives a second response signal from a second ultrasonic receiving transducer at a predetermined distance from the ultrasonic sending transducer. The propagation speed circuit is configured to detect a direct arrival of the acoustic burst in the second response signal and to measure a corresponding propagation speed. The level circuit detects a reflected arrival of the acoustic burst in the first response signal, measures a corresponding time of flight, and derives a fluid level based on the time of flight and the propagation speed.

### CROSS-REFERENCE TO RELATED APPLICATIONS

This application is a continuation of U.S. application Ser. No. 19/042,615, filed 2025 Jan. 31, titled “ROBUST FLOW SENSOR, CONTROLLER, AND METHOD”, which in turn claims the benefit of U.S. Provisional Application No. 63/551,338, filed 2024 Feb. 8 and titled “Ultrasonic flow/level meter with high level of functional safety and online calibration function” by inventor Marek Hustava. Each of these applications is hereby incorporated herein by reference.

### TECHNICAL FIELD

The present disclosure pertains to the field of ultrasonic sensing technology. More specifically, it relates to flow meters, flow sensor controllers, and associated methods that utilize ultrasonic transducers for determining fluid flow rates, levels, and conditions in various environments.

### BACKGROUND

Flow meters are widely employed in industrial processes, environmental monitoring, and fluid management systems to ascertain fluid flow rates, levels, and conditions. Despite their prevalent use and established functionality, there have been ongoing challenges related to measurement precision, reliability, and functional safety. These factors can impact the overall accuracy of readings, necessitating the need for maintenance, redundancy, and frequent recalibration, thereby increasing operational costs and downtime.

Furthermore, integration of online calibration functions and redundant safety checks are increasingly critical in applications demanding high functional safety standards. Modern systems require not only precise measurement capabilities but also the ability to diagnose and alert operators to any operational faults, thereby contributing to improved safety and reduced risk of malfunctions.

### SUMMARY

In light of these challenges, the present disclosure explores systems, methods, and sensors capable of addressing the imperfections associated with existing flow meter technology, offering enhanced reliability while reducing component, system, and maintenance costs.

One illustrative sensor controller includes: a transmitter, a receiver, a time-of-flight circuit, and a phase shift circuit. The transmitter is configured to provide a drive signal to an ultrasonic sending transducer to generate an acoustic burst. The receiver is configured to receive a response signal from an ultrasonic receiving transducer. The time-of-flight circuit is configured to detect an arrival of the acoustic burst in the response signal and to measure a first time of flight associated with that arrival. The phase shift circuit is configured to measure a phase shift of the acoustic burst in the response signal and to determine a second time of flight corresponding to the phase shift.

One illustrative sensing method includes: providing a drive signal to an ultrasonic sending transducer to generate an acoustic burst; receiving a response signal from an ultrasonic receiving transducer; using a time of flight circuit to detect an arrival of the acoustic burst in the response signal and to measure a first time of flight associated with that arrival; and using a phase shift circuit to measure a phase shift of the acoustic burst in the response signal and to determine a second time of flight corresponding to the phase shift.

One illustrative flow sensor includes: a first ultrasonic transducer positionable to emit in a first propagation direction through a fluid flow; a second ultrasonic transducer positionable to emit in an opposite propagation direction through the fluid flow; and a sensor controller having a transmitter, a receiver, a time-of-flight circuit, a phase shift circuit, and control logic. The transmitter is configured to provide a drive signal to an ultrasonic sending transducer to generate an acoustic burst. The receiver is configured to receive a response signal from an ultrasonic receiving transducer, the ultrasonic receiving transducer being a selectable one of the first ultrasonic transducer and the second ultrasonic transducer and the ultrasonic sending transducer being an other one of the first ultrasonic transducer and the second ultrasonic transducer. The time-of-flight circuit is configured to detect an arrival of the acoustic burst in the response signal and to measure a first time of flight associated with that arrival. The phase shift circuit is configured to measure a phase shift of the acoustic burst in the response signal and to determine a second time of flight corresponding to the phase shift. The control logic is configured to swap the ultrasonic sending transducer and the ultrasonic receiving transducer to obtain a first time of flight and a second time of flight for each of the first propagation direction and the opposite propagation direction, and is configured to determine a first time of flight difference between directions and a second time of flight difference between directions.

Another illustrative sensor controller includes: a transmitter, a first receiver, a second receiver, a propagation speed circuit, and a level circuit. The transmitter is configured to provide a drive signal to an ultrasonic sending transducer to generate an acoustic burst. The first receiver is configured to receive a first response signal from a first ultrasonic receiving transducer. The second receiver is configured to receive a second response signal from a second ultrasonic receiving transducer at a predetermined distance from the ultrasonic sending transducer. The propagation speed circuit is configured to detect a direct arrival of the acoustic burst in the second response signal and to measure a corresponding propagation speed. The level circuit is configured to detect a reflected arrival of the acoustic burst in the first response signal, to measure a corresponding time of flight, and configured to derive a fluid level based on the time of flight and the propagation speed.

Another illustrative sensing method includes: providing a drive signal to an ultrasonic sending transducer to generate an acoustic burst; receiving a first response signal from a first ultrasonic receiving transducer; receiving a second response signal from a second ultrasonic receiving transducer at a predetermined distance from the ultrasonic sending transducer; measuring a propagation speed based on a direct arrival of the acoustic burst in the second response signal; measuring a time of flight for a reflected arrival of the acoustic burst in the first response signal; and deriving a fluid level based on the time of flight and the propagation speed.

Yet another illustrative sensor controller includes: a transmitter, a first receiver, a second receiver, and a signal processing circuit. The transmitter is configured to provide a drive signal to an ultrasonic sending transducer to generate an acoustic burst. The first receiver is configured to receive a first response signal from an ultrasonic receiving transducer. The second receiver is configured to receive a second response signal from a MEMS transducer. The signal processing circuit is coupled to the first receiver and configured to measure a first time of flight associated with an arrival of the acoustic burst in the first response signal, and is further coupled to the second receiver and further configured to measure at least one of: a leak noise intensity, an acoustic burst intensity, and a second time of flight associated with an arrival of the acoustic burst in the second response signal.

Yet another illustrative sensing method includes: providing a drive signal to an ultrasonic sending transducer to generate an acoustic burst; receiving a first response signal from an ultrasonic receiving transducer; receiving a second response signal from a MEMS transducer; and using a signal processing circuit to measure a first time of flight associated with an arrival of the acoustic burst in the first response signal and to measure at least one of: a leak noise intensity in the second response signal, an acoustic burst intensity in the second response signal, and a second time of flight associated with an arrival of the acoustic burst in the second response signal.

Still another illustrative sensor controller includes: a transmitter, a receiver, and a signal processing circuit. The transmitter is configured to provide a drive signal to an ultrasonic sending transducer to generate an acoustic burst. The receiver is configured to receive a response signal from an ultrasonic receiving transducer. The signal processing circuit is configured to measure a time of flight for the acoustic burst in the response signal. The transmitter is further configured to measure an impedance of the ultrasonic sending transducer.

Still another illustrative sensing method includes: providing a drive signal to an ultrasonic sending transducer to generate an acoustic burst; receiving a response signal from an ultrasonic receiving transducer; measuring a time of flight for the acoustic burst in the response signal; and monitoring an impedance of the ultrasonic sending transducer.

Still yet another illustrative sensor controller includes: a transmitter, a receiver, a signal processing circuit, and control logic. The transmitter is configured to provide a drive signal to an ultrasonic sending transducer to generate an acoustic burst. The receiver is configured to receive a response signal from an ultrasonic receiving transducer. The signal processing circuit is configured to measure a time of flight for the acoustic burst in the response signal. The control logic is configured to modulate the drive signal to generate a near range communication signal.

Still yet another illustrative sensing method includes: providing a drive signal to an ultrasonic sending transducer to generate an acoustic burst; receiving a response signal from an ultrasonic receiving transducer; measuring a time of flight for the acoustic burst in the response signal; and modulating the drive signal to generate a near range communication signal.

Each of the foregoing illustrative implementations can be embodied individually or conjointly, together with one or more of the following optional features in any suitable combination: 1. control logic configured to determine a flow rate based on both the first time of flight and on the second time of flight. 2. control logic configured to compare the first time of flight to the second time of flight. 3. control logic configured to compare a first flow rate derived from the first time of flight to a second flow rate derived from the second time of flight. 4. the controller is configured to assert a fault signal if the comparison indicates a persistent mismatch. 5. the ultrasonic receiving transducer is a different, separate transducer from the ultrasonic sending transducer. 6. control logic configured to swap the ultrasonic sending transducer and the ultrasonic receiving transducer to obtain a first time of flight and a second time of flight for each burst propagation direction. 7. the control logic determines a first time of flight difference between directions and a second time of flight difference between directions. 8. the control logic is configured to determine a flow rate based on both the first time of flight difference and on the second time of flight difference. 9. the control logic is configured to compare the first time of flight difference to the second time of flight difference. 10. the control logic is configured to compare a first flow rate derived from the first time of flight difference to a second flow rate derived from the second time of flight difference. 11. a second receiver configured to receive a reflection signal from the ultrasonic sending transducer. 12. a Doppler shift circuit configured to detect an echo of the acoustic burst in the reflection signal and to measure a velocity associated with that echo. 13. control logic configured to determine a flow rate based on the velocity when the echo has a magnitude above a threshold. 14. control logic that determines a flow rate based on the fluid level. 15. the first ultrasonic receiving transducer is also the ultrasonic sending transducer. 16. the second ultrasonic receiving transducer is a MEMS transducer. 17. control logic configured to assert a leak detection signal when the leak noise intensity exceeds a predetermined threshold. 18. control logic configured to assert a fault signal when the acoustic burst intensity falls below a given threshold. 19. control logic configured to initiate a cleaning cycle if the second response signal indicates loading of the ultrasonic sending receiver. 20. the signal processing circuit is configured to derive a propagation speed from the second time of flight. 21. control logic configured to assert a fault signal if the impedance is outside a predetermined range. 22. control logic configured to initiate a cleaning cycle if the impedance exceeds a predetermined threshold. 23. control logic configured to monitor the impedance as a function of frequency. 24. based on the impedance as a function of frequency, the control logic is configured to adjust a carrier frequency of the drive signal to match a resonance frequency of the ultrasonic sending transducer. 25. a built-in self-test (BIST) circuit, and control logic configured to assert a fault signal if the BIST circuit indicates a fault in the transmitter, the receiver, the signal processing circuit, or the control logic. 26. the control logic is configured to operate the BIST circuit prior to generating each acoustic burst. 27. comprising control logic configured to compare the acoustic burst in the response signal to a standard waveform. 28. the control logic is configured to assert a fault signal if a mismatch exists between the acoustic burst in the response signal and the standard waveform. 29. the control logic is further configured to initiate a cleaning cycle if a mismatch exists between the acoustic burst in the response signal and the standard waveform. 30. the ultrasonic sending transducer is also the ultrasonic receiving transducer. 31. the signal processing circuit is configured to demodulate the response signal to receive a near range communication response. 32. a second receiver coupled to a second ultrasonic receiving transducer to receive a near range communication response. 33. control logic configured to determine an open channel flow rate based at least in part on the time of flight. 34. the control logic is configured to determine a closed channel flow rate based on the time-of-flight difference.

### BRIEF DESCRIPTION OF THE FIGURES

FIG. 1 is a plan view of an illustrative flow meter arrangement for a closed channel flow.

FIG. 2 is a perspective view an illustrative flow meter arrangement for an open channel flow.

FIG. 3 is a block diagram of an illustrative sensor controller with supporting components for ultrasonic transmission and reception.

FIG. 4A is a block diagram of illustrative signal processing and diagnostic circuitry within the sensor controller.

FIG. 4B is a block diagram of illustrative phase calculation circuitry that may be used within the sensor controller.

FIG. 4C is a graph showing cosine and sine function values that may be stored in a look-up table for low-power phase calculation.

FIG. 5 is a schematic of a direct drive circuit for a piezoelectric transducer.

FIG. 6 is a graph displaying various switch signal timings and resulting voltage levels for transducer activation.

FIG. 7 is a flow diagram of an illustrative flow sensing method employing multiple independent measurements for robust sensing.

FIG. 8 is a flow diagram of an illustrative flow sensing method employing a second receive transducer for propagation speed measurement, leak detection, and/or fault monitoring.

FIG. 9 is a flow diagram of an illustrative flow sensing method employing impedance monitoring and fault detection for enhanced reliability.

FIG. 10 is a flow diagram of an illustrative near range communications method for an interrogator device.

FIG. 11 is a flow diagram of an illustrative near range communications method for a responder device.

### DETAILED DESCRIPTION

It should be understood that the drawings and following description do not limit the disclosure, but on the contrary, they provide the foundation for one of ordinary skill in the art to understand all modifications, equivalents, and alternatives falling within the scope of the claim language.

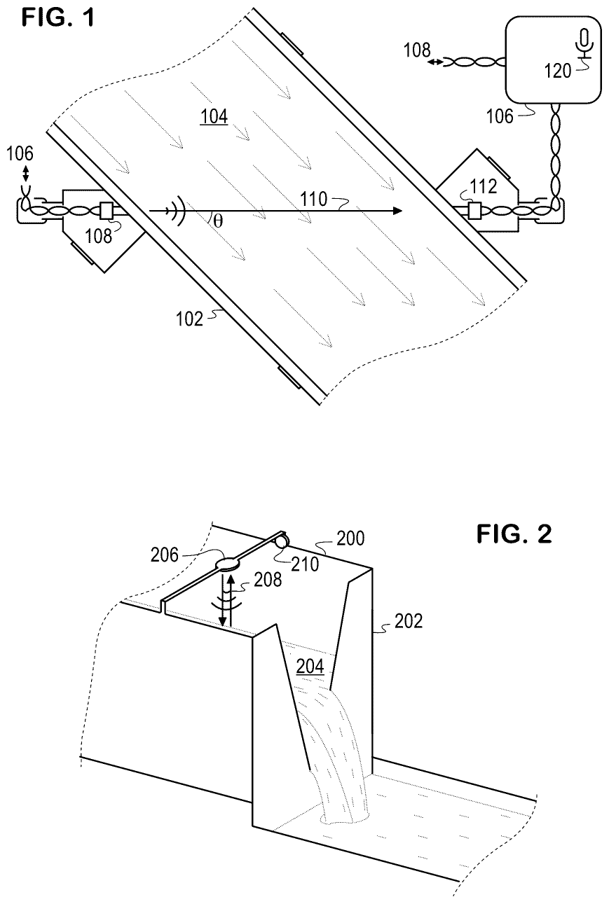

To aid understanding, FIGS. 1 and 2 show illustrative contexts in which the described sensor controller and methods may be employed. FIG. 1 shows a closed-channel fluid measurement system with a pipe 102 having through which a fully confined fluid flow 104 is directed. The fluid may be a liquid, a gas, or any flowable composition including inhomogeneous mixtures with suspended solids. The pipe 102 has a predetermined cross-sectional flow area A and may be configured to provide a reasonably uniform laminar flow stream having an average flow velocity v along the pipe's longitudinal axis.

A sensor controller 106 is connected to the system, controlling the operation of ultrasonic transducers 108, 112. An ultrasonic sending transducer 108 is positioned on one side of the pipe 102, emitting an acoustic burst or other acoustic signals along a propagation path 110 across a diameter of the pipe intersecting the longitudinal axis at an angle θ. On the opposite side, an ultrasonic receiving transducer 112 is situated to capture the acoustic signals sent by the sending transducer 108. Sending transducer 108 may further be configured to receive reflections of the acoustic bursts from, e.g., bubbles, droplets, or particles entrained in the fluid flow. The sensor controller 106 processes these signals to evaluate parameters such as time of flight and phase shift as described further below.

The sensor controller 106 periodically swaps the roles of the ultrasonic transducers, such that transducer 112 may become the ultrasonic sending transducer and transducer 108 may become the ultrasonic receiving transducer, enabling the sensor controller 106 to determine parameters for opposing propagation directions along path 110. The downstream time of flight is shortened by an amount determined by the fluid flow velocity and the upstream time of flight is similarly extended. By combining (e.g., by determining a difference between reciprocals of) the upstream and downstream measurements, the sensor controller can, in combination with other geometrical parameters (such as pipe diameter and intersection angle θ) measure the fluid flow velocity v. When combined with pipe cross section, the fluid flow velocity enables the sensor controller to determine and monitor a volumetric flow rate. If the fluid density is known or independently measured, the volumetric flow rate can be readily converted to a mass flow rate. Given the tight and well-understood correlation of fluid flow velocity, volumetric flow rate, and mass flow rate, they are each contemplated herein as being encompassed by the generic term “fluid flow rate”.

Certain enhancements to this arrangement provide enhanced reliability and robustness without unduly increasing implementation costs. These enhancements may include an integrated microphone 120 to potentially enhance sound capture capabilities for additional analysis or communication purposes. The arrangement of these components enables precise measurement and monitoring of parameters associated with fluid flow 104.

FIG. 2 shows an open channel 200 through which fluid flow 204 is directed over a weir 202 or other obstruction. As is well understood in the civil engineering arts, the geometry of the channel and obstructions cause the fluid flow's depth to vary monotonically as a function of the fluid flow rate. Thus, by monitoring the fluid level, a suitably programmed sensor controller can determine the flow depth and thereby monitor the fluid flow rate and cumulative flow volume.

Accordingly, FIG. 2 further shows a level sensor 206 positioned above the fluid flow 204 to monitor the surface level. The illustrated level sensor 206 uses an ultrasonic sending transducer to emit an acoustic burst 208 and an ultrasonic receiving transducer (which may be the same as the sending transducer) to detect a reflection of the acoustic burst 208 from the fluid's surface. (In an alternative configuration, the level sensor 206 is positioned below the fluid's surface and oriented upward.) The level sensor 206 includes a sensor controller to measure the time of flight and the associated distance to the surface of the fluid flow 204. With this distance, the sensor controller can use stored geometrical parameters, formulas, and/or look up tables to determine depth of the fluid flow and the associated fluid flow rate, from which a cumulative flow volume can be readily derived.

As a potential enhancement, the illustrated arrangement includes a second ultrasonic receiving transducer 210 positioned at a predetermined distance from the ultrasonic sending transducer of the level sensor 206. This transducer 210 is designed to receive the acoustic burst 208 along a direct propagation path, enabling the sensor controller to determine a propagation speed of the acoustic burst. Because the speed of sound in air depends on temperature, pressure, and humidity, this measurement of propagation speed enables more accurate measurement of the distance to the fluid surface. Adjustments and modifications to the positions of the level sensor 206 and the ultrasonic receiving transducer 210 can be made to accommodate various fluid flow conditions, providing versatility in different operational environments.

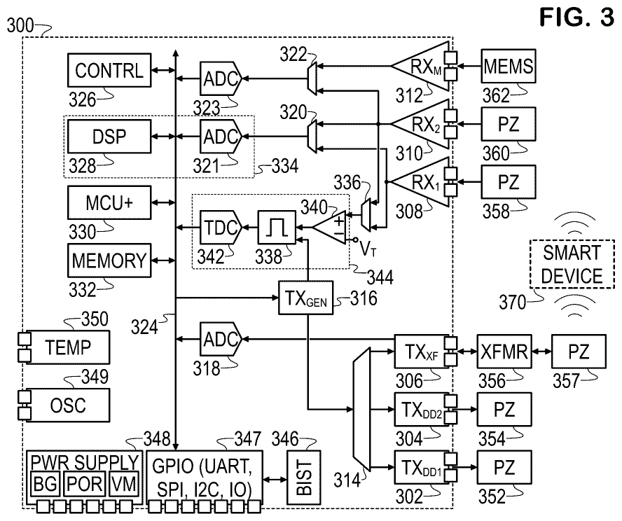

FIG. 3 shows an illustrative sensor controller 300, which may be implemented as a monolithic integrated circuit chip having an arrangement of interconnected components, designed to handle ultrasonic signal processing and communication tasks. At the heart of the system, the control logic 326 coordinates signal flow and processing through an internal bus 324. The transmitter components, including transmitter 302, transmitter 304, and transmitter 306, are configured to deliver drive signals to various ultrasonic sending transducers, such as ultrasonic sending transducer 352, ultrasonic sending transducer 354, and (via a transformer 356) ultrasonic sending transducer 357, generating acoustic bursts that emanate from these transducers. To offer configuration flexibility, transmitters 302, 304 may be direct-drive transmitters using voltage drivers as described further below, while transmitter 306 may be a current driver configured to supply drive current to a transformer 356, enabling the transformer to supply an elevated voltage signal to transducer 357.

Transmitter 306 may further provide a sensing voltage to analog-to-digital converter (ADC) 318, enabling the sensor controller 300 to monitor the voltage response of the ultrasonic sending transducer 357 during driving and/or post-driving reverberation. As described further below, transmitters 302, 304 may be configured for current or impedance monitoring, enabling the sensor controller 300 to monitor the impedance of the ultrasonic sending transducers 352, 354 during driving. Though three sending transducers are shown in FIG. 3, most contemplated sensor arrangements will employ only one or two ultrasonic sending transducers.

Sensor controller 300 further includes a receiver 308, receiver 310, and receiver 312, respectively coupled to an ultrasonic receiving transducer 358, ultrasonic receiving transducer 360, and microphone 362. Transducers 358, 360, 362 are all shown for completeness; in practice one or more of these may be omitted. While ultrasonic receiving transducers 358, 360 are shown and implementable as individual elements, it is contemplated that each receiving transducer may also serve as one of the ultrasonic sending transducers 352, 354, 357. For example, the sensor may have a single transducer that is driven by one of the transmitters to generate an acoustic burst before being used by one of the receivers to detect a reflection of the acoustic burst. As another example, the sensor may have a transducer that is used to generate an acoustic burst and a second transducer used to receive the response. In this case, the second transducer can be used to generate a subsequent acoustic burst and the first transducer may be used to receive a subsequent response. The ultrasonic sending and receiving transducers may be piezoelectric (PZ) elements with optional supporting discrete components. Microphone 362 may similarly be a piezoelectric element, though a micro-electromechanical systems (MEMS) transducer may be preferred for higher sensitivity.

A demultiplexer 314 forwards the digital transmit signal from transmit signal generator 316 to a selected one of the transmitters 302-306 to drive the corresponding ultrasonic sending transducer to generate an acoustic burst. An arrangement of multiplexers 320, 322 selectively couple the analog receive signals from receivers 308, 310, 312, to ADC 321 and ADC 323, which digitize the receive signals. Control logic 326 coordinates the operation of components 302-323 to deliver digital receive signals to digital signal processor (DSP) 328, microcontroller 330, memory 332, and/or application specific integrated circuitry (ASIC) modules within control logic 326. In addition to providing software or firmware instructions and programmable parameters for the signal processing components, memory 332 may provide buffering of the digital receive signals, intermediate signal streams, and measurement signals, but also may provide nonvolatile storage for logs of the measurement results that can be stored for later retrieval or delivered in real time to other components or systems.

Signal processing tasks can be allocated in various ways among the microcontroller unit (MCU) 330, DSP 328, and control logic 326, which may be primarily distinguishable in terms of their balance between software and hardware implementation of their desired functionality. FIG. 3 shows the phase shift measurement circuit 334 as being implemented mainly within the digital signal processor 328, but the disclosed modules can be distributed in other ways, with some functions implemented by the ASIC modules and others by software in the microcontroller.

FIG. 3 further shows a multiplexer 336 directing a selected analog receive signal from receivers 308, 310 to a time-of-flight measurement circuit 344. The time-of-flight measurement circuit 344 includes a pulse generator 338, a comparator 340, and a time-to-digital converter TDC 342. When the transmit signal generator 316 operates to generate an acoustic burst, it provides an asserted Start signal to pulse generator 338. The pulse generator 338 asserts its output signal until the Stop signal from the comparator 340 is asserted. The comparator 340 asserts the Stop signal when the selected analog receive signal exceeds a predetermined threshold voltage VT, indicating the arrival of an acoustic burst in the selected receive signal. In some alternative implementations, the pulse generator 338 incorporates a zero-crossing detector for increased precision. The pulse generator 338 de-asserts its output (1) after the envelope of the receive signal exceeds the threshold voltage, and (2) the zero-crossing detector detects a subsequent zero crossing in the receive signal. TDC 342 converts width of the pulse output by pulse generator into a digital value indicating its duration. Suitable implementation examples may include: (1) a high frequency clock counter, and (2) an integrator coupled to an analog-to-digital converter.

Sensor controller 300 may further include supporting components such as built-in self-test (BIST) circuitry 346, a general-purpose input/output (GPIO) interface module 347, a power supply 348, an oscillator 349, and a temperature sensor circuit 350. The BIST circuitry 346 may be configured to test functionality of the various other components including the transmitters, the receivers, the signal processing circuitry, and the control logic. The GPIO interface 347 may be configured to provide digital input/output signal functionality for commands, control signals, and data. Various digital I/O and serial communications protocols may be supported including, e.g., UART, SPI, I2C, and 5V IO.

Power supply 348 provides power conditioning using one or more bandgap (BG) references, a voltage monitoring (VM) circuit, and a power-on reset (POR) module to implement the sequence of power-on operations. One or more oscillators 349 may employ a crystal to generate various on-chip clock signals for synchronizing operations of the various other components. The temperature sensor circuit 350 may be coupled to an external thermocouple or other temperature sensor to monitor environmental conditions.

An additional feature that may be offered by the sensor controller 300 is near range communication with a smart device 370 such as a smart phone or similar device having a microphone that can sense ultrasonic signals and a speaker that can transmit ultrasonic signals. As described further below, the sensor controller 300 and smart device 370 can modulate and demodulate ultrasonic signals to transmit and receive commands and responses to convey data between a sensor and a portable device, facilitating configuration of the sensor, monitoring of the sensor's performance and retrieval of sensor data.

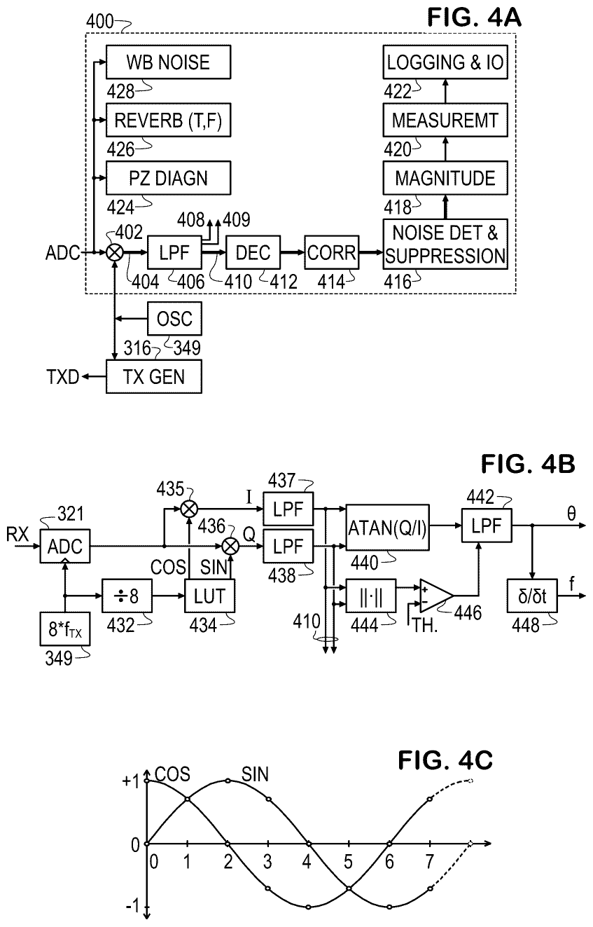

FIG. 4A shows a signal processing circuit 400 that incorporates various components for processing ultrasonic signals. The various components may be implemented as control logic hardware or firmware modules implemented by the DSP 328 or microcontroller 330. Oscillator 349 supplies a carrier signal to transmit signal generator 316, which produces the digital transmit signal TXD to generate acoustic bursts for flow rate sensing. (Optionally, transmit signal generator 316 may be further configured to modulate the digital transmit signal to produce modulated ultrasonic signals for near range communications with a smart device.) The carrier signal from oscillator 349 is also supplied to a digital quadrature mixer 402 to downcovert the digital receive signals from a given ADC into a baseband “zero intermediate frequency” ZIF signal 404 having in-phase and quadrature phase components.

A low pass filter 406 processes the ZIF signal 404 to remove noise that is out of the signal band associated with the acoustic burst and to prevent aliasing when the filtered baseband signal 410 is supplied for decimation by the decimator 412. The low pass filter 406 may further combine the quadrature components of the filtered baseband signal to determine a phase shift measurement signal 408 that measures the digitized receive signal phase relative to the carrier signal from oscillator 349, and may further determine a frequency measurement signal 409 that represents the frequency offset between the digitized receive signal and the carrier signal. The frequency measurement signal 409 may be a derivative of the phase shift measurement signal 408, which in turn can be determined from the trigonometric relationship between the quadrature components. Decimator 412 reduces the sample rate of the filtered baseband signal 410 to reduce processing requirements for subsequent modules. A correlator 414 may use a correlation filter to convert the decimated baseband signal into a correlated signal, indicating when the digitized receive signal includes an acoustic burst that matches an expected waveform. A noise detection and suppression module 416 operates on the correlated signal, applying attenuation compensation to amplify peaks representing echoes and applying a nonlinear function to suppress noise. A magnitude determination module 418 converts the quadrature signal components into a magnitude signal, which may be processed by a time-of-flight measurement module 420 to determine the timing of peaks indicating the travel time of the acoustic burst. Data logging and integration with external systems is facilitated by the logging and I/O module 422, which manages data storage and interfacing.

Additional diagnostic and noise analysis features are provided by the diagnostic module 424, the reverberation module 426, and the wideband noise measurement module 428. The wideband noise measurement module 428 assesses the noise characteristics across the full spectrum of the digitized receive signal. The reverberation module 426 optionally measures the frequency and duration of the transducer's reverberation after transmission of an acoustic burst. The diagnostic module 424, alone or in combination with modules 426, 428, analyzes the digitized response signal to detect and diagnose any transducer fault conditions. Some fault conditions may be indicated by, e.g., an excessively short reverberation periods (which may be due to a disconnected or defective transducer, suppressed vibration, or the like), while others may be indicated by an excessively long reverberation period (defective mounting, inadequate damping resistance, or the like). The diagnostic module 424 may detect and classify multiple such transducer fault conditions, storing the appropriate fault codes in internal registers, from whence they may be communicated to the control logic.

It is noted that modules 412-424 can be reordered or otherwise rearranged as needed to provide the desired signal processing. In at least some implementations, these modules may be disabled at least intermittently to reduce processing requirements and associated power consumption.

FIG. 4B shows additional detail for an illustrative low-power circuit for determining phase shift measurement signal 408 and frequency measurement signal 409. In this implementation, the oscillator 349 generates a clock signal at 8× the transmit carrier frequency to enable 8× oversampling by the ADC 321. A frequency divider/counter 432 uses the clock signal to cycle through eight output values for a look up table 434. As shown in FIG. 4C, the look up table outputs correspond to cosine and sine functions. The sine function values are shifted by two table locations from the cosine function values. In some contemplated implementations, the look up table is replaced with logic that supplies the three output magnitudes 0, 0.71, and 1 with suitable sign changes.

Multipliers 435 and 436 produce products of the digitized receive signal with the cosine and sine function values, respectively, corresponding to the in-phase (I) and quadrature phase (Q) components of the receive signal. Low pass filters 437, 438 remove noise that is out of the signal band associated with the acoustic burst and to prevent aliasing when the filtered components 410 are decimated.

A phase calculation module 440 may calculate the receive signal phase as the arctangent of the ratio between the quadrature phase component and the in-phase component. When the in-phase component is zero (or much smaller than the quadrature component), the module 440 may determine the phase to be 90 degrees. A low pass filter 442 may be used to smooth the phase measurement.

We note that the phase calculation is only meaningful when the receive signal is valid, i.e., when an acoustic burst is being received. Accordingly, a magnitude calculation module 444 may combine the in-phase and quadrature phase components to determine the receive signal magnitude. A comparator 446 provides an output to disable the phase calculation module 440 or filter 442 when the receive signal magnitude is below a predetermined threshold. In some implementations, the magnitude calculation is filtered or otherwise accumulated to ensure the magnitude is above the threshold for at least a minimum time before enabling module 440 or 442 to provide a nonzero output.

A derivative circuit 448 may operate on the phase measurement output 408 to provide a frequency measurement output 409. The phase measurement output may be converted to a secondary time-of-flight measurement.

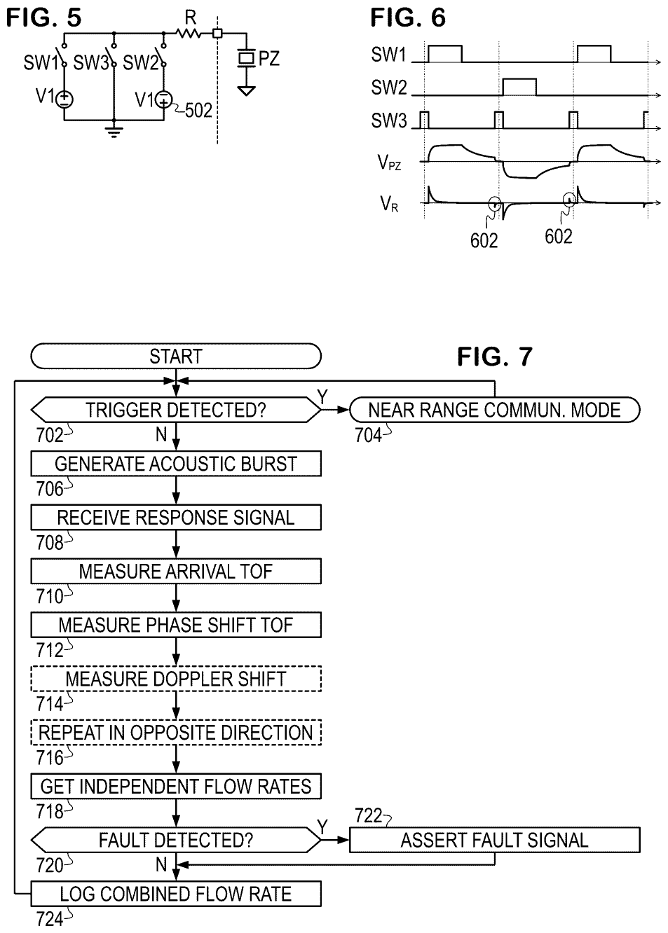

FIG. 5 shows an illustrative implementation of the direct drive transmitters 302, 304, having three switches SW1, SW2, SW3, that respectively couple a positive supply voltage V1, a negative supply voltage 502, and an intermediate “ground” voltage to a piezoelectric ultrasonic sending transducer PZ. If all three switches are off, the driver is in a high impedance state. A current sensor or small sensing resistance R is provided in series with the transducer to enable sensing of the current flow to the transducer.

The switches may be operated in accordance with the control signal timing shown in the first three curves of FIG. 6. Switches SW1, SW2, SW3 conduct when their respective control signals are asserted (high), and isolate when their respectively control signals are de-asserted (low). When SW3 conducts, the sending transducer is coupled to ground as indicated by the voltage curve Vpz. Switch SW3 is then opened and switch SW1 is closed to momentarily apply the positive supply voltage to the sending transducer. The voltage curve Vpz quickly converges to the positive supply voltage even as the piezoelectric element's deformation gains momentum. When the control signals have a periodicity near that of the transducer's resonant frequency, the momentum continues after the switch SW1 is opened, causing the voltage curve Vpz to decay. For the other half of the excitation cycle, switch SW3 couples the transducer to ground before switch SW2 momentarily applies the negative supply voltage.

The voltage curve VR shows a voltage across the sensing resistance, which is proportional to the transducer's current flow. The voltage curve exhibits distinct peaks corresponding to the charging and discharging of the sending transducer. The charging peaks occur when the grounding switch SW3 opens and either switch SW1 or SW2 closes. These peaks are consistent across a wide frequency range. However, the discharge peaks 602 created when grounding switch SW3 closes are a strong function of frequency, reaching a minimum size when the control signals have a frequency matching the transducer's resonant frequency. A rectified and filtered version of the voltage curve VR can thus serve as an indicator whether such resonant frequency matching has been achieved, enabling the control logic to adapt the control signals as needed to accommodate resonant frequency variations attributable to aging and changing environmental conditions.

FIG. 7 is a flow diagram of an illustrative flow sensing method employing multiple independent measurements for robust sensing. It begins in block 702, checking for a trigger to determine whether the sensor should enter near range communications mode 704, discussed further below. The trigger may be, for example, a button press, a detection of a beacon signal, or a period timer elapsing. Detection of the trigger causes the sensor to enter near range communications mode 704. The method returns to the beginning when exiting near range communication mode 704.

Otherwise, in block 706, the sensor generates an acoustic burst with an ultrasonic sending transducer and in block 708 receives a response signal with an ultrasonic receiving transducer. In block 710, the sensor processes the response signal to detect the arrival of the acoustic burst and to determine the associated time of flight (TOF). This can be achieved, e.g., using a time-of-flight measurement circuit 344 (FIG. 3). In block 712, the sensor processes the response signal to determine the phase shift of the received acoustic burst relative to the carrier frequency. This phase shift may be determined using the mixer 402 and low pass filter 406. As discussed previously, this phase shift corresponds to the travel time of the acoustic burst and can be readily converted into a time-of-flight measurement independent of the measurement made in block 710.

Block 714 represents an optional measurement of Doppler shift that may be obtained using the mixer 402 and low pass filter 406. In the sensor arrangement of FIG. 1, the flow stream may include bubbles, solids, or other causes of acoustic impedance variation that induce reflections of the acoustic burst back to the ultrasonic sending transducer. The frequency shift is essentially proportional to the flow stream velocity. Block 716 represents a repetition of blocks 706-714 with the roles of the ultrasonic sending transducer and ultrasonic receiving transducer swapped. In the sensor arrangement of FIG. 1, this repetition enables time of flight measurements to be obtained with the acoustic burst propagating in the opposite direction of the original measurements. These measurements for the opposite direction of propagation are combined with the measurements in the original direction to obtain TOF differences proportional to the fluid flow velocity.

In block 718, the time-of-flight measurements of blocks 710 and 712, or the TOF differences obtained using the measurements in block 716, are used to determine independent measurements of the fluid flow velocity. Optionally, a fluid flow velocity measurement may also be obtained from the Doppler shift measurement in blocks 714 and 716.

In block 720, the independent measurements are compared. If any persistent discrepancies are detected, the sensor asserts a fault signal in block 722, which may be communicated to a user to signal a need for maintenance or repair. In block 724, the sensor may combine the independent measurements to obtain a combined flow rate measurement. This combination process may be a selection of the measurements determined to be most accurate or consistent or may be a weighted sum configured to enhance measurement accuracy. The sensor may communicate the combined flow rate measurement to a logging service or monitoring system and/or store the combined flow rate measurement for later retrieval.

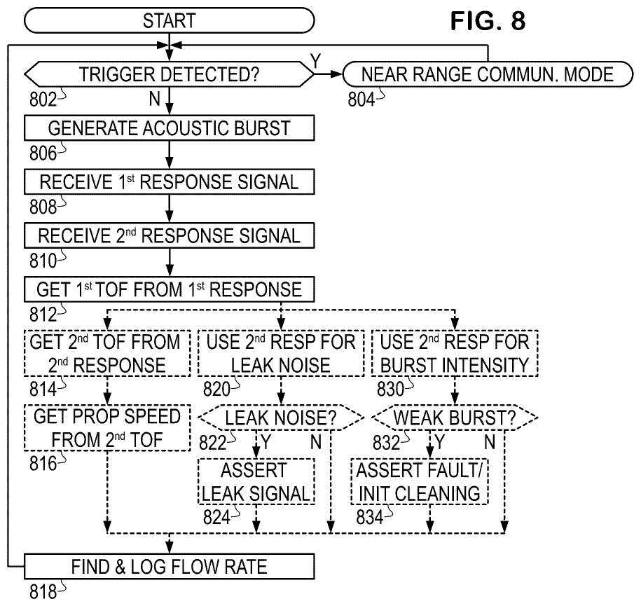

FIG. 8 is a flow diagram of an illustrative flow sensing method employing a second receive transducer for propagation speed measurement, leak detection, and/or fault monitoring. As with the method of FIG. 7, the illustrative sensing method begins in block 802, checking for a trigger to determine whether the sensor should enter near range communications mode 804. Otherwise, in block 806, the sensor generates an acoustic burst with an ultrasonic sending transducer and in block 808 receives a first response signal with a first ultrasonic receiving transducer. In block 810, the sensor also uses a second ultrasonic receiving transducer to receive a second response signal. The second ultrasonic receiving transducer may be a piezoelectric transducer or alternatively may be a microphone having a microelectromechanical systems (MEMS) element.

In block 812, the sensor uses the first response signal to determine a first time of flight having a dependence on the fluid flow velocity. Thereafter, the flow diagram of FIG. 8 provides three parallel paths to illustrate different ways to use the second response signal. In block 814, the sensor uses the second response signal to determine a second time of flight that indicates the acoustic burst's propagation speed (i.e., the speed of sound) but is independent of the fluid flow velocity. To provide this measurement in an open channel system, the microphone or ultrasonic receiving transducer is positioned at a known distance from the ultrasonic sending transducer, in a direction where it can be reached without entering the fluid flow. In block 816, the sensor determines the acoustic burst's propagation speed, enabling a more accurate determination of the surface level of the fluid flow. In block 818, the sensor determines the flow rate measurement and conveys the measurement to the logging service or system monitor and/or stores the measurement for later retrieval.

In block 820, the sensor processes the second response to detect the wideband “hiss” typically associated with a fluid leak from a pipe. In block 822, the sensor determines whether the level of wideband noise exceeds a predetermined threshold, and if so, asserts a leak detection signal or some other form of alarm signal in block 824 to notify the user.

In block 830, the sensor processes the second response to determine the amplitude or intensity of the acoustic burst. In block 832, the sensor determines whether the amplitude or intensity falls below a predetermined threshold indicating loading or weakening of the ultrasonic sending transducer. If so, in block 834, the sensor initiates a transducer cleaning operation and/or asserts a fault signal to notify the user of a need for maintenance or repair. In some contemplated implementations, a cleaning operation may be performed by driving the ultrasonic sending transducer with an elevated drive signal to dislodge material from the transducer's surface.

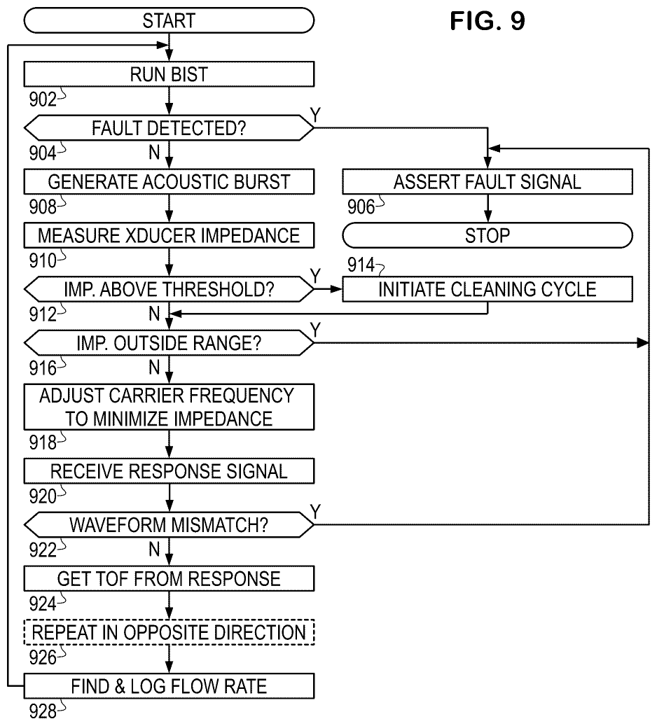

FIG. 9 is a flow diagram of an illustrative flow sensing method employing impedance monitoring and fault detection for enhanced reliability. It begins in block 902 with performing a built-in self-test BIST diagnostic on the transmitter, receiver, and signal processing components of the sensor. In block 904, the sensor determines whether the BIST results indicate a fault, and if so, in block 906 the sensor asserted a fault signal to notify the user of a need for maintenance or repair. The sensor may then cease operation.

Otherwise, in block 908, the sensor generates an acoustic burst using an ultrasonic sending transducer. In block 910, the sensor measures an impedance of the sending transducer, e.g., by monitoring the current flow during acoustic burst generation with a voltage-based driver, or monitoring the voltage during acoustic burst generation with a current-based driver. In block 912, the sensor determines whether the impedance is above a predetermined threshold, and if so, in block 914 the sensor initiates a cleaning operation to clear debris from the transducer surface. If the cleaning operation is unsuccessful, or the impedance is determined in block 916 to be outside a predetermined range, the method may proceed to block 906. Otherwise, in block 918, the sensor adjusts the carrier frequency, which over multiple iterations enables the sensor to determine the frequency dependence of the impedance and to find the carrier frequency that minimizes the transducer impedance.

In block 920, the sensor uses an ultrasonic receiving transducer to receive a response to the acoustic burst. In block 922, the sensor compares the response signal to an expected waveform to verify that the receiving transducer is operating as expected. If a mismatch is identified, the sensor returns to block 906. Otherwise, in block 924, the sensor detects the arrival of the acoustic burst and measures the time of flight. In optional block 926, the sensor may repeat the operations of blocks 908-924 to determine a time-of-flight measurement for the opposite propagation direction. In block 928, the sensor determines the flow rate measurement and conveys the measurement to the logging service or system monitor and/or stores the measurement for later retrieval.

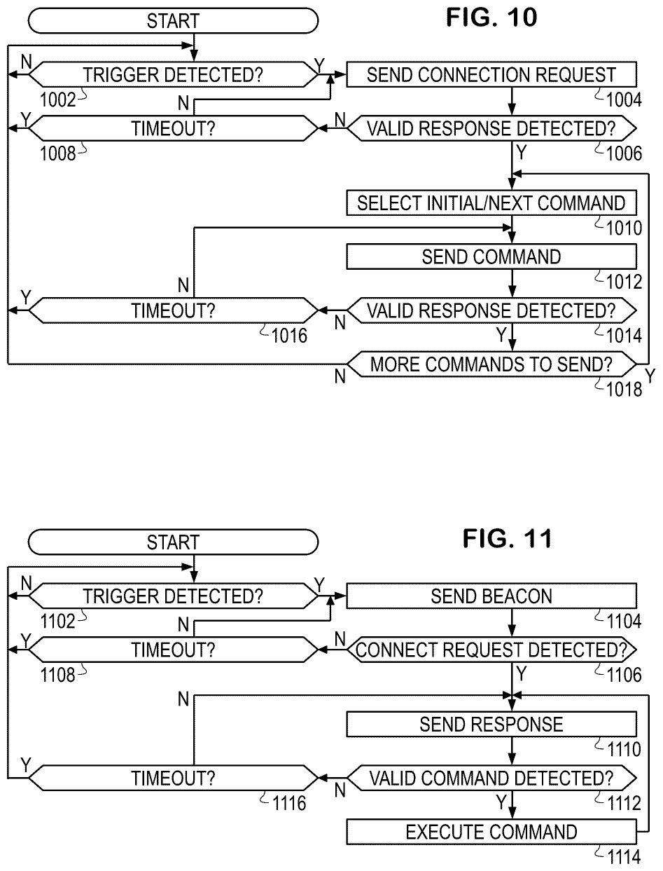

FIG. 10 is a flow diagram of an illustrative near range communications method for an interrogator device such as a smart phone or other portable smart device 370. In block 1002, the device determines whether a connection should be attempted. The trigger for a connection attempt may be, e.g., the reception of an acoustic beacon signal from the sensor, a determination by a navigation or position tracking system that the user has entered the sensor's vicinity, an opening or awakening of an app on the device, a physical tap or shake of the device, or a voice command from the user. The device continues in block 1002 until a trigger is detected. Once detected, the device generates an acoustic signal containing a connection request in block 1004.

The device checks for an acoustic signal containing a response message in block 1006. If no valid response message is detected within a predetermined time window, the device checks whether a connection attempt timer has elapsed in block 1008. If so, the process returns to block 1002 to await another trigger. Otherwise, another connection request message is sent in block 1004. Once a valid response message is received in block 1006, the device proceeds to block 1010.

In block 1010, the device may select a command to be sent to the sensor in block 1012. In block 1012, the device sends the command as an acoustic signal. In block 1014, the device checks for an acoustic signal containing a response message. If no valid response message is detected within a predetermined time window, the device checks whether a command timer has elapsed in block 1016. If so, the process returns to block 1002 to await another trigger. Otherwise, the command message is retransmitted in block 1012. Once a valid response message is received in block 1014, the device proceeds to block 1018 to determine if more commands are to be sent. If so, the device returns to block 1010. Otherwise, the device returns to block 1002.

The sequence of commands can vary, but may include, e.g., a diagnostic command to obtain the sensor's identifying information and status, a download command to retrieve any stored measurement data, and a configuration command to set any available configuration parameters for the sensor's operation.

FIG. 11 is a flow diagram of an illustrative near range communications method for a sensor or other responder device. In block 1102, the sensor determines whether a connection should be attempted. The trigger for a connection attempt may be, e.g., the detection of nearby motion, detection of footsteps or other sounds, the actuation of a sensor button or control mechanism, detection of a physical knock on (or kick or jarring of) of the sensor, detection of a voice command, or detection of a connection request. The sensor continues in block 1102 until a trigger is detected. Once detected, the sensor generates an acoustic signal containing a beacon in block 1104.

The sensor checks for an acoustic signal containing a connection request message in block 1106. If no valid request message is detected within a predetermined time window, the sensor checks whether a connection attempt timer has elapsed in block 1108. If so, the process returns to block 1102 to await another trigger. Otherwise, another beacon message is sent in block 1104. Once a valid request message is received in block 1106, the sensor proceeds to block 1110.

In block 1110, the sensor may send a response message to the device. The response message may include the result of a previously transmitted command, or other information. For example, the response message may include sensor status information such as whether the sensor is active, identifying information, current configuration information, the number of stored measurements, the available storage memory, current flow rate measurements, a download of stored flow rate measurements, fault alerts. Such information may be provided by default or in response to an information request command.

After sending the response message in block 1110, the sensor may check for an acoustic signal containing another command message in block 1112. If a valid command message is received, the sensor may attempt to execute the command in block 1114, after which the process moves to block 1110 to communicate a response message acknowledging the command and communicating the results, e.g., whether the command was successfully performed. If no valid command message is detected within a predetermined time window, the sensor checks whether a command timer has elapsed in block 1116. If so, the process returns to block 1102 to await another trigger. Otherwise, the previous response message is retransmitted in block 1110.

Numerous modifications, equivalents, and alternatives will become apparent to those skilled in the art once the above disclosure is fully appreciated. It is intended that the following claims be interpreted to embrace all such modifications, equivalents, and alternatives where applicable.

What is claimed is:

1. A sensor controller comprising:
a transmitter configured to provide a drive signal to an ultrasonic sending transducer to generate an acoustic burst;
a first receiver configured to receive a first response signal from a first ultrasonic receiving transducer;
a second receiver configured to receive a second response signal from a second ultrasonic receiving transducer at a predetermined distance from the ultrasonic sending transducer;
a propagation speed circuit configured to detect a direct arrival of the acoustic burst in the second response signal and to measure a corresponding propagation speed;
a level circuit configured to detect a reflected arrival of the acoustic burst in the first response signal, to measure a corresponding time of flight, and to derive a fluid level based on the time of flight and the propagation speed.

2. The sensor controller of claim 1, further comprising control logic that determines a flow rate based on the fluid level.

3. The sensor controller of claim 1, wherein the first ultrasonic receiving transducer is also the ultrasonic sending transducer.

4. The sensor controller of claim 1, wherein the second ultrasonic receiving transducer is a MEMS transducer.

5. A sensing method comprising:
providing a drive signal to an ultrasonic sending transducer to generate an acoustic burst;
receiving a first response signal from a first ultrasonic receiving transducer;
receiving a second response signal from a second ultrasonic receiving transducer at a predetermined distance from the ultrasonic sending transducer;
measuring a propagation speed based on a direct arrival of the acoustic burst in the second response signal;
measuring a time of flight for a reflected arrival of the acoustic burst in the first response signal; and
deriving a fluid level based on the time of flight and the propagation speed.

6. The sensing method of claim 5, further comprising determining a flow rate based on the fluid level.

7. The sensing method of claim 5, wherein the first ultrasonic receiving transducer is also the ultrasonic sending transducer, and wherein the second ultrasonic receiving transducer is a MEMS transducer.

8. A sensor controller comprising:
a transmitter configured to provide a drive signal to an ultrasonic sending transducer to generate an acoustic burst;
a first receiver configured to receive a first response signal from an ultrasonic receiving transducer;
a second receiver configured to receive a second response signal from a MEMS transducer; and
a signal processing circuit coupled to the first receiver and configured to measure a first time of flight associated with an arrival of the acoustic burst in the first response signal, and coupled to the second receiver and configured to measure at least one of: a leak noise intensity, an acoustic burst intensity, and a second time of flight associated with an arrival of the acoustic burst in the second response signal.

9. The sensor controller of claim 8, further comprising control logic configured to assert a leak detection signal when the leak noise intensity exceeds a predetermined threshold.

10. The sensor controller of claim 8, further comprising control logic configured to assert a fault signal when the acoustic burst intensity falls below a given threshold.

11. The sensor controller of claim 8, further comprising control logic configured to initiate a cleaning cycle if the second response signal indicates loading of the ultrasonic sending transducer.

12. The sensor controller of claim 8, wherein the signal processing circuit is configured to derive a propagation speed from the second time of flight.

13. The sensor controller of claim 9, wherein the control logic is further configured to swap the ultrasonic sending transducer and the ultrasonic receiving transducer to obtain a first time of flight for each burst propagation direction, wherein the control logic determines a flow rate based on a first time of flight difference between directions.

14. A sensing method comprising:
providing a drive signal to an ultrasonic sending transducer to generate an acoustic burst;
receiving a first response signal from an ultrasonic receiving transducer;
receiving a second response signal from a MEMS transducer; and
using a signal processing circuit to measure a first time of flight associated with an arrival of the acoustic burst in the first response signal and to measure at least one of: a leak noise intensity in the second response signal, an acoustic burst intensity in the second response signal, and a second time of flight associated with an arrival of the acoustic burst in the second response signal.

15. The sensing method of claim 14, further comprising asserting a leak detection signal when the leak noise intensity exceeds a predetermined threshold.

16. The sensing method of claim 14, further comprising asserting a fault signal when the acoustic burst intensity falls below a given threshold.

17. The sensing method of claim 14, further comprising initiating a cleaning cycle if the second response signal indicates loading of the ultrasonic sending transducer.

18. The sensing method of claim 14, further comprising deriving a propagation speed from the second time of flight.

19. The sensing method of claim 15, further comprising:
swapping the ultrasonic sending transducer and the ultrasonic receiving transducer to obtain a first time of flight for each burst propagation direction; and
determining a flow rate based on a first time of flight difference between directions.
